(19) United States
(12) Patent Application Publication
(10) Pub. No.: US 2016/0261138 A1
(43) Pub. Date: Sep. 8, 2016

(54) WIRELESS CHARGING RECEIVER

(71) Applicant: Che-Min Wu, Torrance, CA (US)

(72) Inventor: Che-Min Wu, Torrance, CA (US)

(21) Appl. No.: 15/063,477

(22) Filed: Mar. 7, 2016

Related U.S. Application Data
(60) Provisional application No. 62/128,927, filed on Mar. 5, 2015.

(51) Int. Cl. H02J 7/02; H02J 7/04; H02J 7/00

(52) U.S. Cl. CPC H02J 7/025; H02J 7/0042; H02J 7/04

(57) ABSTRACT

A wireless charging receiver may include a main body, a connecter to electrically connect to batteries or other electronic devices, a receiving unit to pick and receive wireless power transmission, and a wireless charging module to convert the power into an electrical current. In one embodiment, a coil may be included in the receiving unit to realize the wireless charging. In another embodiment, the magnetic strip can be used to attach to a surface of other devices to secure the wireless charging receiver thereon. When a wireless power transmission comes in, the receiving unit can realize the wireless charging and pick it up from an electromagnetic field, and the wireless charging module is configured to convert it into an electric current that can be stored in the rechargeable battery through the electrical connection between the receiver and the battery.

### CROSS-REFERENCE TO RELATED APPLICATIONS

This application claims priority under 35 U.S.C. §119 (e) to U.S. Provisional Patent Application Ser. No. 62/128,927, filed on Mar. 5, 2015, the entire contents of which are hereby incorporated by reference.

### FIELD OF THE INVENTION

The present invention generally relates to a wireless charging receiver, and more particularly to a wireless charging receiver that can be used for any electronic devices and majority of electronic batteries.

### BACKGROUND OF THE INVENTION

Mobile phones are used for a variety of purposes, including keeping in touch with family members, conducting business, and having access to a telephone in the event of an emergency. Some people carry more than one cell phone for different purposes, such as for business and personal use. More recently, smartphones emerged to quickly replace traditional mobile phones. Simply speaking, smartphones are mobile phones equipped with more advanced computing capability and connectivity to perform much more tasks than basic mobile phones. More particularly, smartphones typically combine the features of a mobile phone with some other popular consumer devices, such as a personal digital assistant (PDA), a media player, a digital camera, or a GPS navigation unit. Modern smartphones may include more features including a touchscreen computer, a web browser and a plurality of application software (“Apps”).

One of the most important concerns of smartphone users is the battery life. As stated above, modern smartphones can perform just like a mini computer, however, unlike computers that may be used with the power cords for most of the time, smartphone users usually carry the phones with them and the battery inside the phone may be a sole power source thereof. Therefore, it may be inconvenient for the users if the battery cannot last long enough and the smartphone may lose the portability if the user has to charge it frequently.

To solve the battery issues in smartphones and other mobile devices such as tablets, various kinds of power banks have been developed to help people more conveniently charge the mobile devices. More recently, wireless charging has become more and more popular with the rrtain benefit being ease of use. If the electronic device that is to be charged does not have a built-in wireless charging receiver, the electronic device may be equipped with a sleeve or similar structure to function as a wireless charging receiver.

However, every electronic device may be different in style, size, battery position, charging port, etc., so the wireless charging receiver and/or connector may have to be modified according to the differences of these devices. Also, current wireless charging receivers are thick, which reduces the aesthetic value of the electronic device being charged. Furthermore, most wireless charging receivers are device-specific, namely if the wireless charging receiver can be used in electronic device A, it may not be able to used in device B. For example, in U.S. Pat. No. 8,395,353 to Wang et al., the portable electronic device 2 is held by the wireless charging receiver 3, so the electric power is transmitted to the chargeable battery of the portable electronic device 2 through the wireless charging receiver 3. However, not all portable electronic devices can be charged in this manner due to the differences between the electronic devices discussed above.

In U.S. Pat. Pub. No.: 2012/0194124 to Toivola et al., the wireless charging receiver 13 is actually attached to the electronic device 11 as a sleeve as shown in FIG. 2. However, this kind of attachment is only specific for devices like electronic device 11, not for many other electronic devices that need to be charged. Therefore, there remains a need for a new and improved wireless charging receiver to overcome the problems stated above.

### SUMMARY OF THE INVENTION

It is an object of the present invention to provide an ultra-thin wireless charging receiver that can be used in any electronic devices to support wireless charging standard such as A4WP, PMA, WPC, etc.

It is another object of the present invention to provide an ultra-thin wireless charging receiver that can be installed or built in rechargeable batteries, which may turn the rechargeable batteries into wireless rechargeable batteries.

It is a further object of the present invention to provide an ultra-thin wireless charging receiver that can be shrunk with advanced process and be embedded into IC or SOC.

It is still a further object of the present invention to provide an ultra-thin wireless charging receiver that cab be magnetized or have magnetized boarder so that it is able attach to a magnetized transmitter if needed.

In one aspect, a wireless charging receiver may include a main body, a connecter to electrically connect to batteries or other electronic devices, a receiving unit to pick and receive wireless power transmission, and a wireless charging module to convert the power into an electrical current. In one embodiment, a coil may be included in the receiving unit to realize the wireless charging. The wireless charging receiver may further include a flex cable and a magnetic strip. In one embodiment, one end of the flex cable is connected to the main body and the other end is connected to the connector, and the flex cable can be extended to help the connector reach the nodes of the battery. In another embodiment, the magnetic strip can be used to attach to a surface of other devices to secure the wireless charging receiver thereon.

When in use, the wireless charging receiver can be electronically connect to a rechargeable battery, and is secured thereon by the magnetic strip, in one embodiment. The connector with a pair of electrodes are in contact with the nodes respectively to electrically connect the receiver with the battery. When a wireless power transmission comes in, the receiving unit can realize the wireless charging and pick it up, and the wireless charging module is configured to convert it into a battery power that can be stored in the rechargeable battery through the electrical connection between the receiver and the battery.

In another aspect, the wireless charging receiver can be attached to an electronic device, and is secured thereon by the magnetic strip, in one embodiment. The connector can be in contact with at least one connecting port to electrically connect the receiver with the electronic device. When a wireless power transmission comes in, the receiving unit can realize the wireless charging and pick it up from an electromagnetic field, and the wireless charging module is configured to convert it into an electric current that can be stored in a rechargeable battery in the electronic device through the electrical connection between the receiver and the electronic device.

Comparing with typical wireless charging receivers, the wireless charging receiver in the present invention is ultra-thin, so it can be easily attached and secured on any rechargeable batteries or electronic devices. Furthermore, the ultra-thin wireless charging receiver can be installed or built in rechargeable batteries, which may turn the rechargeable batteries into wireless rechargeable batteries. Namely, the integration of the wireless charging receiver and the rechargeable battery can be considered a power source. Without compromising the integrity thereof, the wireless charging receiver is configured to receive wireless power transmission from outside sources, such as wireless charger or the like, converts it into electric current and charges the battery attached to the receiver. More importantly, the wireless charging receiver in the present invention can be attached to batteries with different configurations, the battery-specific or device-specific issue in conventional wireless charging receivers can be eliminated.

### BRIEF DESCRIPTION OF THE DRAWINGS

FIG. 1 is a prior art disclosing a system of transmitting electric power to the wireless charging receiver through the wireless charging transmitter.

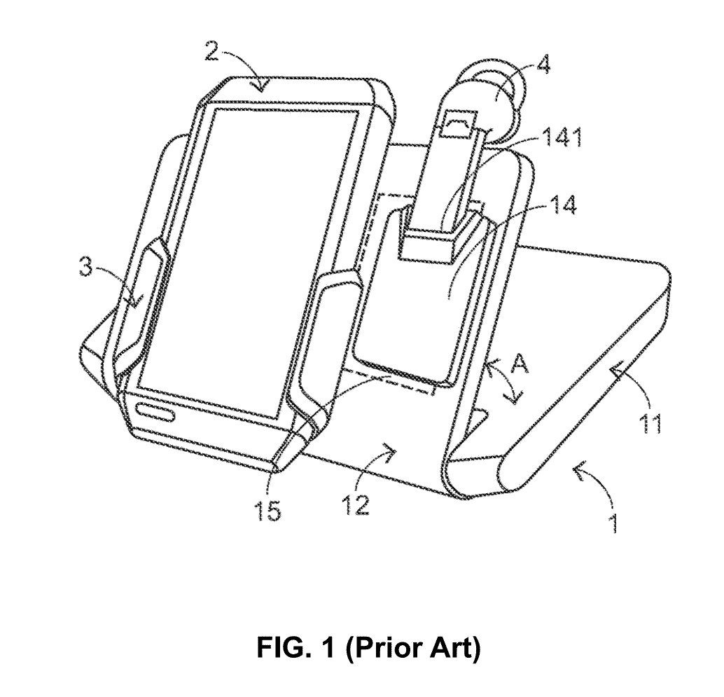

FIG. 2 is a prior art disclosing a portable device attached to a wireless charging receiver electrically connected to a wireless charging transmitter and power supply.

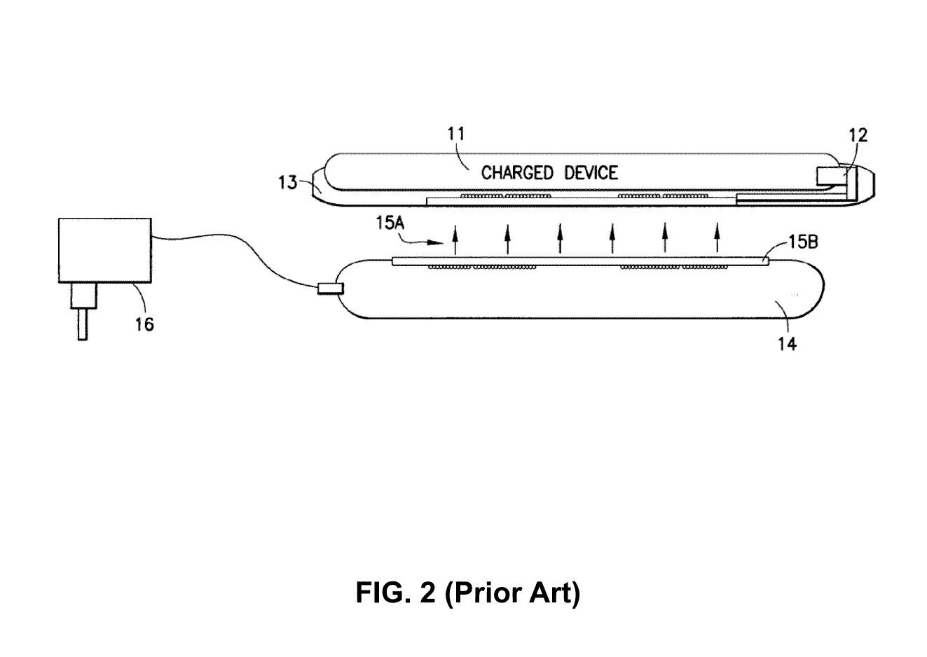

FIG. 3 illustrates a schematic view of the wireless charging receiver in the present invention.

FIG. 4 illustrates a schematic view of the wireless charging receiver electronically connected to the rechargeable battery in the present invention.

FIG. 5 illustrates a schematic view of the wireless charging receiver electronically connected to another type of rechargeable battery in the present invention.

FIG. 6 illustrates a schematic view of the wireless charging receiver electronically connected to an electronic device in the present invention.

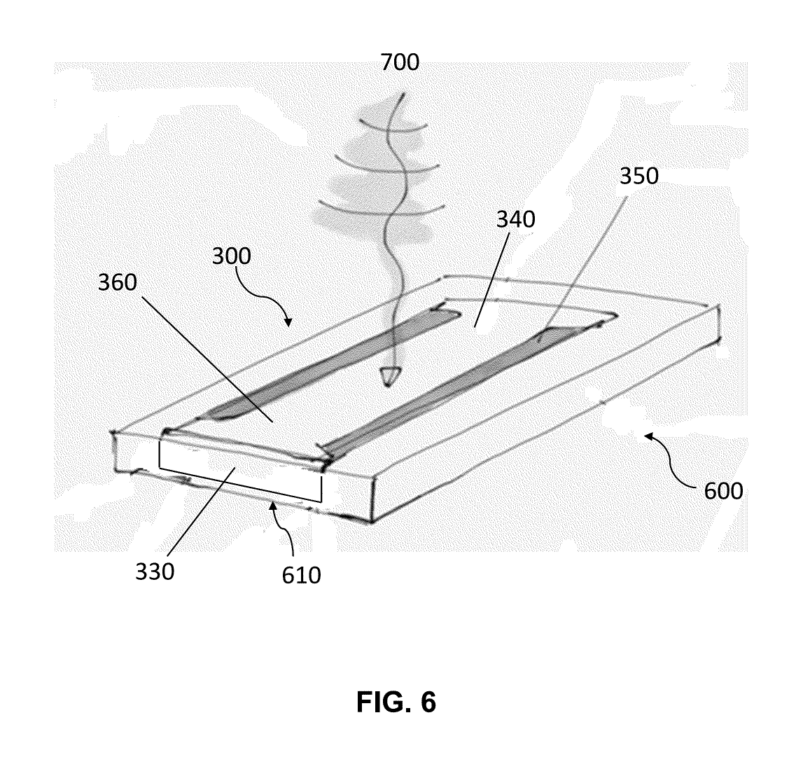

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

Typical wireless charging system applies power to a charging apparatus including a coil therein, and charges a battery using an induced current generating in a wireless charging receiver included in a mobile terminal, or a battery using a magnetic field generating in the coil in the charging apparatus. The coil is actually configured to emit electromagnetic pulses to realize the wireless charging.

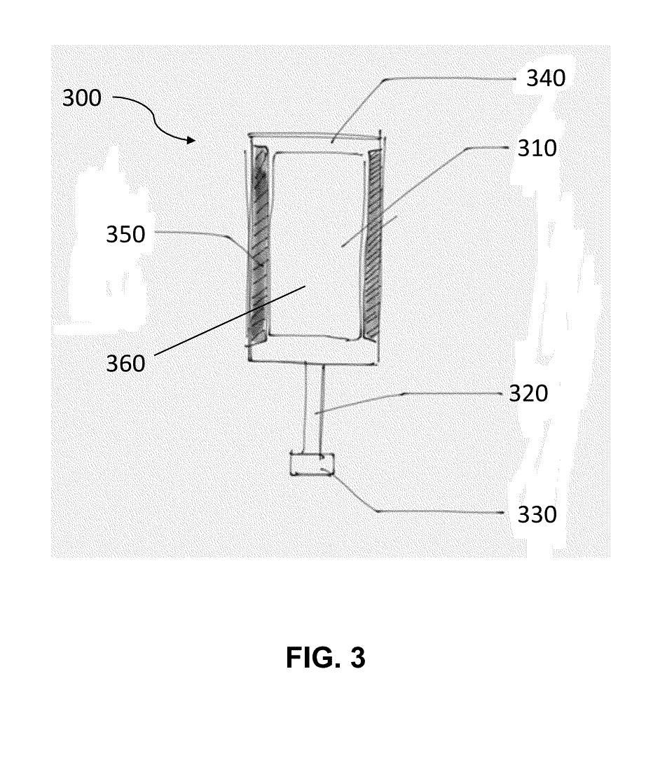

In one aspect, referring to FIG. 3, a wireless charging receiver 300 may include a main body 310, a connecter 330 to electrically connect to batteries or other electronic devices, a receiving unit 340 to pick and receive wireless power transmission, and a wireless charging module 360 to convert the wireless power into an electric current. In one embodiment, a coil may be included in the receiving unit 340 to realize the wireless charging. The wireless charging receiver 300 may further include a flex cable 320 and a magnetic strip 350. In one embodiment, one end of the flex cable 320 is connected to the main body 310 and the other end is connected to the connector 330, and the flex cable 320 can be extended to help the connector 330 reach the nodes of the battery. In another embodiment, the magnetic strip 350 can be used to attach to a surface of other devices to secure the wireless charging receiver 300 thereon.

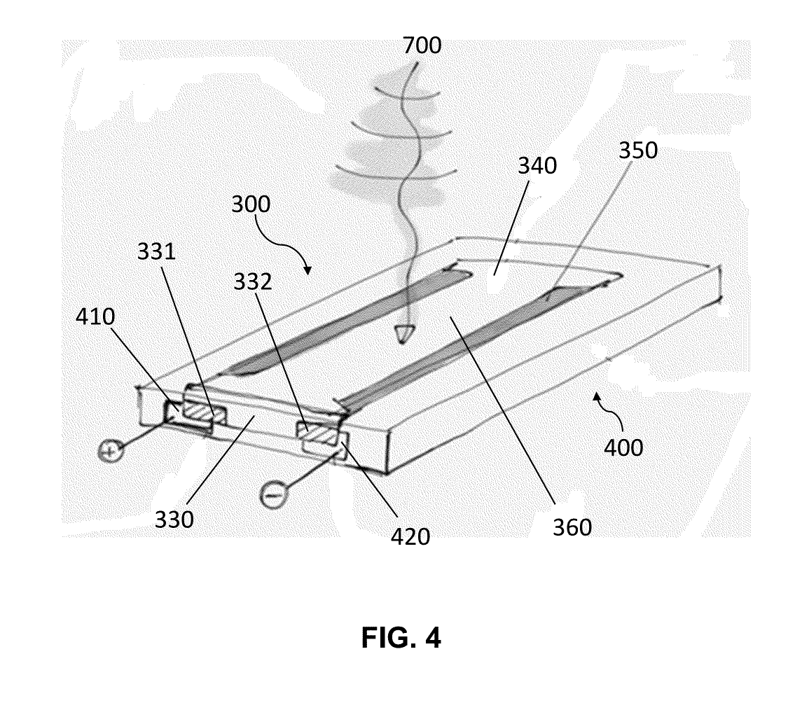

When in use, referring to FIG. 4, the wireless charging receiver 300 can be electronically connect to a rechargeable battery 400, and is secured thereon by the magnetic strip 350, in one embodiment. The connector 330 with a pair of electrodes (331, 332) are in contact with the nodes (410, 420) respectively to electrically connect the receiver 300 with the battery 400. When a wireless power transmission 700 comes in, the receiving unit 340 can realize the wireless charging and pick it up from an electromagnetic field, and the wireless charging module 360 is configured to convert it into an electric current that can be stored in the rechargeable battery 400 through the electrical connection between the receiver 300 and the battery 400.

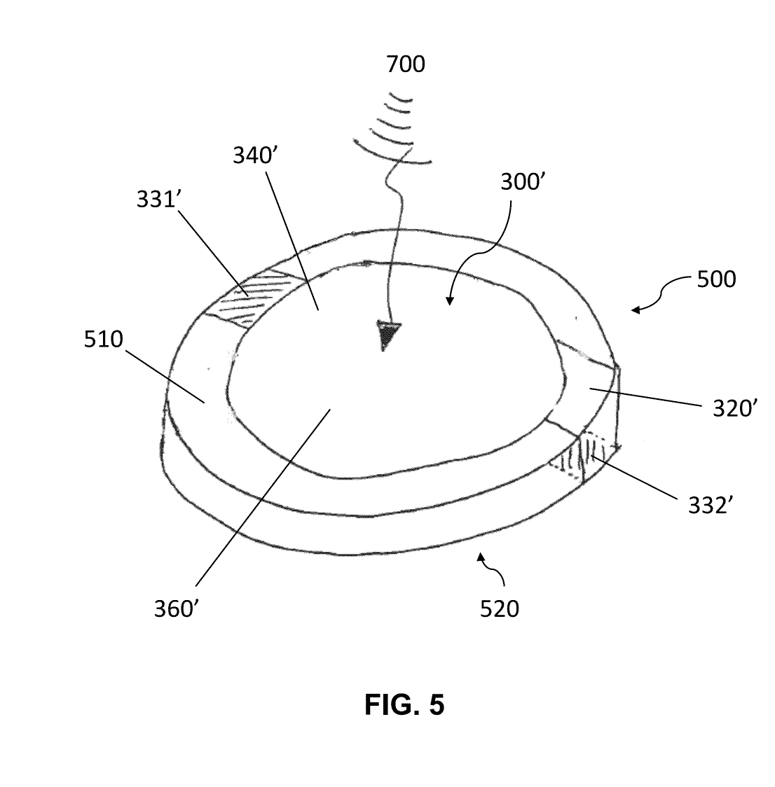

As stated above, the batteries may be different in in style, size, battery position, charging port, etc., and the wireless charging receiver in the present invention can be easily modified according to the change of the batteries. For example, as shown in FIG. 5, a wireless charging receiver 300′ can be used for a battery 500 having a first node on a top portion 510 of the battery 500 and a second node on a bottom portion 520 thereof. More specifically, the wireless charging receiver 300′ can be secured on the top portion 510 of the battery 500 where a first electrode 331′ is in contact with a first node 510 of the battery 500, while the second electrode 332′ can be extended to and in contact the bottom portion 520 of the battery 500, so the wireless charging receiver 300′ can be electrically connected with the battery 500. When the wireless power transmission 700 comes in, the receiving unit 340′ can realize the wireless charging and pick it up, and the wireless charging module 360′ is configured to convert it into a battery power that can be stored in the rechargeable battery 500 through the electrical connection between the receiver 300′ and the battery 500.

In another aspect, as shown in FIG. 7, the wireless charging receiver 300 can be attached to an electronic device 600, and is secured thereon by the magnetic strip 350, in one embodiment. The connector 330 can be in contact with at least one connecting port 610 to electrically connect the receiver 300 with the electronic device 600. When a wireless power transmission 700 comes in, the receiving unit 340 can realize the wireless charging and pick it up from an electromagnetic field, and the wireless charging module 360 is configured to convert it into an electric current that can be stored in a rechargeable battery in the electronic device 600 through the electrical connection between the receiver 300 and the electronic device 600. In one embodiment, the connecting port 610 is electrically connected with the rechargeable battery of the electronic device 600.

Comparing with typical wireless charging receivers, the wireless charging receiver 300 (300′) in the present invention is ultra-thin, so it can be easily attached and secured on any rechargeable batteries or electronic devices. Furthermore, the ultra-thin wireless charging receiver 300 (300′) can be installed or built in rechargeable batteries, which may turn the rechargeable batteries into wireless rechargeable batteries. Namely, the integration of the wireless charging receiver 300 (300′) and the rechargeable battery can be considered a power source. Without compromising the integrity thereof, the wireless charging receiver 300 (300′) is configured to receive wireless power transmission from outside sources, such as wireless charger or the like, converts it into electric current and charges the battery attached to the receiver. More importantly, the wireless charging receiver 300 (300′) in the present invention can be attached to batteries with different configurations as shown in FIGS. 4 and 5, the battery-specific or device-specific issue in conventional wireless charging receivers can be eliminated.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A wireless charging system comprising:
a wireless charging receiver including:
a main body;
a connector having one or more electrodes to electrically connect with corresponding nodes of a rechargeable battery;
a receiving unit having at least one coil to realize and receive wireless power transmission from an electromagnetic field; and
a wireless charging module to convert the wireless power transmission into an electrical current to charge the rechargeable battery.

2. The wireless charging system of claim 1, wherein the wireless charging receiver further includes a magnetic strip to secure the wireless charging receiver on the rechargeable battery.

3. The wireless charging system of claim 1, wherein the wireless charging receiver further includes a flex cable, one end of which is connected to the main body and the other end is connected to the connector.

4. The wireless charging system of claim 1, wherein the wireless charging receiver includes at least one coil to realize the wireless charging.

5. A wireless charging system comprising:
a wireless charging receiver including:
a main body;
a connector having one or more electrodes to connect with a connecting port of an electronic device;
a receiving unit having at least one coil to realize and receive wireless power transmission from an electromagnetic field; and
a wireless charging module to convert the wireless power transmission into an electrical current to charge a rechargeable battery of the electronic device through the electrical connection between the connector of the wireless charging receiver and the connecting port of the electronic device.

6. The wireless charging system of claim 1, wherein the wireless charging receiver further includes a magnetic strip to secure the wireless charging receiver on the electronic device.

7. The wireless charging system of claim 1, wherein the wireless charging receiver further includes a flex cable, one end of which is connected to the main body and the other end is connected to the connector.

8. The wireless charging system of claim 1, wherein the wireless charging receiver includes at least one coil to realize the wireless charging.
